(19) United States
(12) Patent Application Publication
(10) Pub. No.: US 2008/0053283 A1
(43) Pub. Date: Mar. 6, 2008

(54) Abutment plate assembly for cutting machine

(75) Inventors: Chih-Cheng Lin, Lung-Ching Hsiang (TW); Msin-Msin Wang, Wu-Chi Chen (TW); Chun-Te Lee, Taichung City (TW); Hsin-Yi Cheng, Nan-Tou City (TW); Ming-Hui Huang, Ta-An Hsiang (TW); Jiann-Fang Chang, Tung-Shih Chen (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: P&F BROTHER INDUSTRIAL CORPORATION

(21) Appl. No.: 11/826,859

(22) Filed: Jul. 19, 2007

(30) Foreign Application Priority Data
Sep. 1, 2006 (TW) 095132331

(51) Int. Cl. B26D 7/06

(52) U.S. Cl. 83/440

(57) ABSTRACT

An abutment plate assembly for a cutting machine includes an abutment plate unit, an extension plate unit, and a locking unit. The abutment plate unit includes a sliding rail unit having a generally T-shaped cross section. The extension plate unit is formed with a slide slot having a generally T-shaped cross section and engaging the sliding rail. The locking unit includes a pressing member movable vertically within the slide slot, a resilient member for biasing the pressing member to move away from the abutment plate unit, and a rotary lever unit. The rotary lever unit is rotatable so as to move the pressing member toward the abutment plate unit until the pressing member presses the extension plate against the abutment plate unit to thereby lock the extension plate unit on the abutment plate unit.

### BACKGROUND OF THE INVENTION

1. Field of the Invention

This invention relates to a cutting machine, and more particularly to an abutment plate assembly for a cutting machine, which allows a workpiece to abut thereagainst during a cutting operation of the cutting machine.

2. Description of the Related Art

Referring to FIGS. 1 and 2, a conventional abutment plate assembly 10 for a cutting machine, such as a sawing machine, includes an abutment plate 11 disposed movably on a machine bed 1, an extension plate 12 disposed movably on the abutment plate 11, and a lock bolt 13 for locking the extension plate 12 on the abutment plate 11. The abutment plate 11 and the extension plate 12 have abutment surfaces 111, 121, respectively. The abutment surfaces 111, 121 are aligned with each other, and cooperate to allow a workpiece (not shown) to abut thereagainst during a cutting operation of the cutting machine. The abutment plate 11 has a slide slot 112 that is rectangular in cross section. The extension plate 12 includes a sliding rail 122 extending downwardly therefrom, having a rectangular cross section, and received slidably within the slide slot 112 in the abutment plate 11. The lock bolt 13 is disposed rotatably on the abutment plate 11, and is rotatable to press against the extension plate 12 for locking the extension plate 12 on the abutment plate 11.

The aforesaid conventional abutment plate assembly 10 suffers from the following disadvantages:

(1) Since the slide slot 112 and the sliding rail 122 are rectangular in cross section, when the extension plate 12 moves along the sliding slot 112, a portion of the extension plate 12 may move vertically relative to the abutment plate 11, thereby resulting in unsmooth sliding movement of the extension plate 12.

(2) When the extension plate 12 is locked on the abutment plate 11 by the lock bolt 13, due to the small contact area between the lock bolt 13 and the extension plate 12, an end of the extension plate 12 distal from the lock bolt 13 may be lower than an opposite end of the extension plate 12 proximate to the lock bolt 13, as shown in FIG. 2. In other words, the extension plate 12 cannot be locked firmly on the abutment plate 11.

### SUMMARY OF THE INVENTION

The object of this invention is to provide an abutment plate assembly for a cutting machine, which can overcome the above-mentioned disadvantages associated with the prior art.

According to this invention, an abutment plate assembly for a cutting machine includes an abutment plate unit, an extension plate unit, and a locking unit. The abutment plate unit includes a sliding rail unit having a generally T-shaped cross section. The extension plate unit is formed with a slide slot having a generally T-shaped cross section and engaging the sliding rail unit. The locking unit includes a pressing member movable vertically within the slide slot, a resilient member for biasing the pressing member to move away from the abutment plate unit, and a rotary lever unit. The rotary lever unit is rotatable so as to move the pressing member toward the abutment plate unit until the extension plate presses against the abutment plate unit to thereby lock the extension plate unit on the abutment plate unit.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a perspective view of a conventional abutment plate assembly for a cutting machine;

FIG. 2 is a side view of the conventional abutment plate assembly;

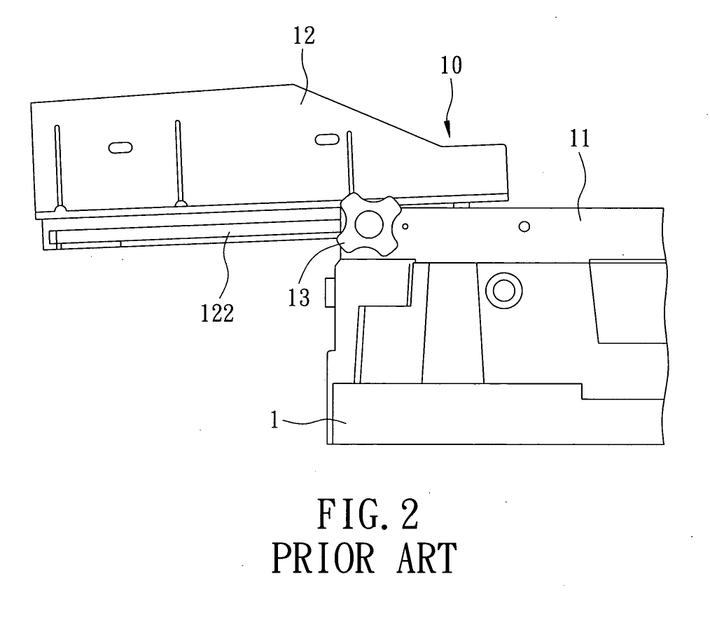

FIG. 3 is an exploded perspective view of the preferred embodiment of an abutment plate assembly according to this invention;

FIG. 4 is a side view of the preferred embodiment;

FIG. 5 is top view of the preferred embodiment;

FIG. 6 is a sectional view taken along Line 6-6 in FIG. 5;

FIG. 7 is a sectional view taken along Line 7-7 in FIG. 5;

FIG. 8 is a sectional view taken along Line 8-8 in FIG. 5;

FIG. 9 is an assembled front perspective view of the preferred embodiment;

FIG. 10 is a fragmentary, assembled rear perspective view of the preferred embodiment;

FIG. 11 is a schematic, partly sectional view of the preferred embodiment, illustrating a connection between a pressing member and a rotary lever unit;

FIG. 12 is an assembled front perspective view of the preferred embodiment, illustrating how an extension plate unit is moved on an abutment plate unit;

FIG. 13 is a sectional view of the preferred embodiment, illustrating how the extension plate unit is retained on the abutment plate unit by the pressing member; and

FIG. 14 is a fragmentary rear perspective view of the preferred embodiment, illustrating how a position-limiting rod is operated to allow for removal of the extension plate unit from the abutment plate unit.

### DETAILED DESCRIPTION OF THE PREFERRED EMBODIMENT

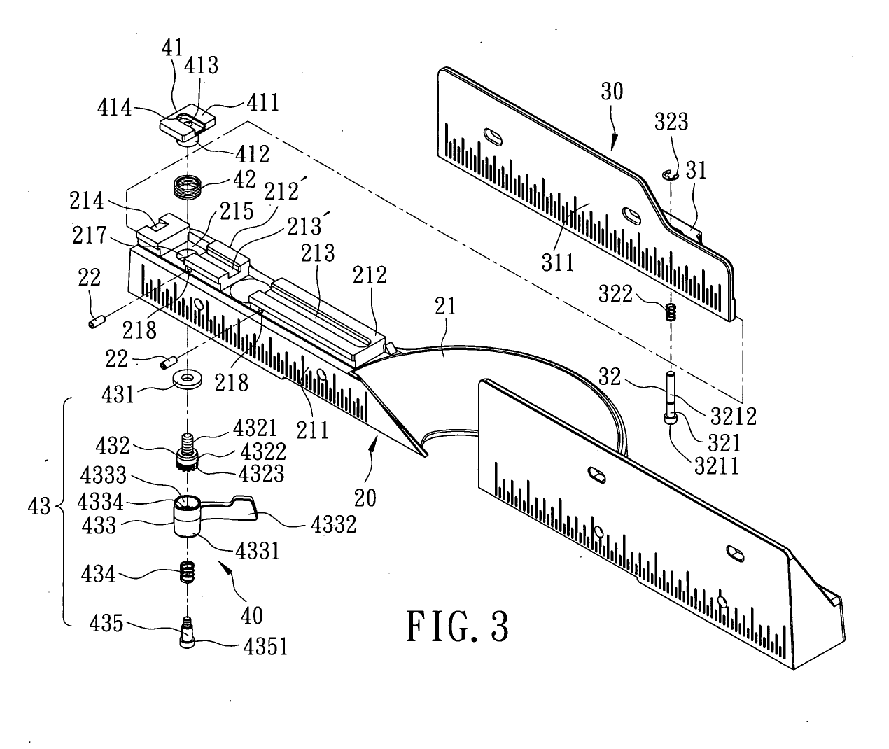

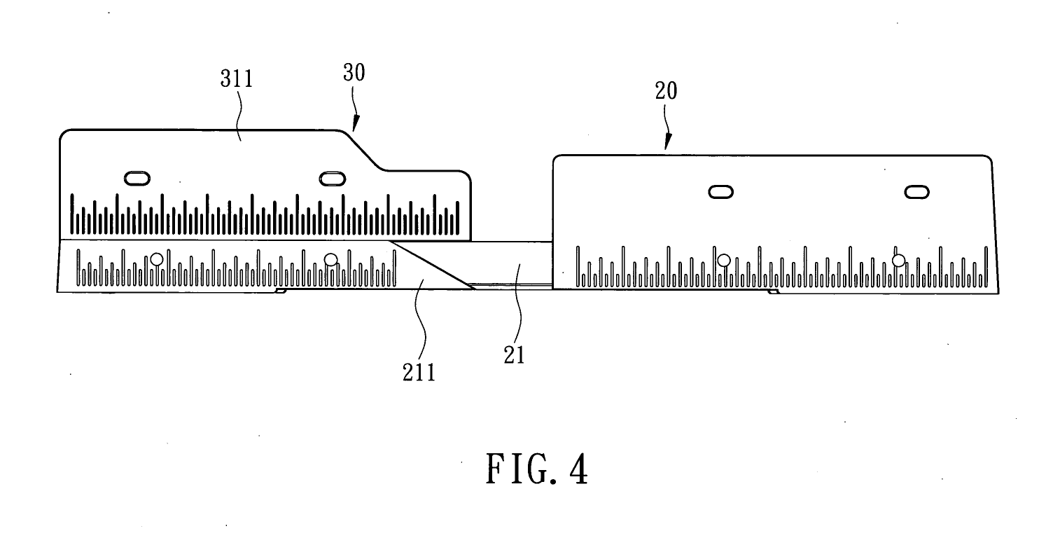

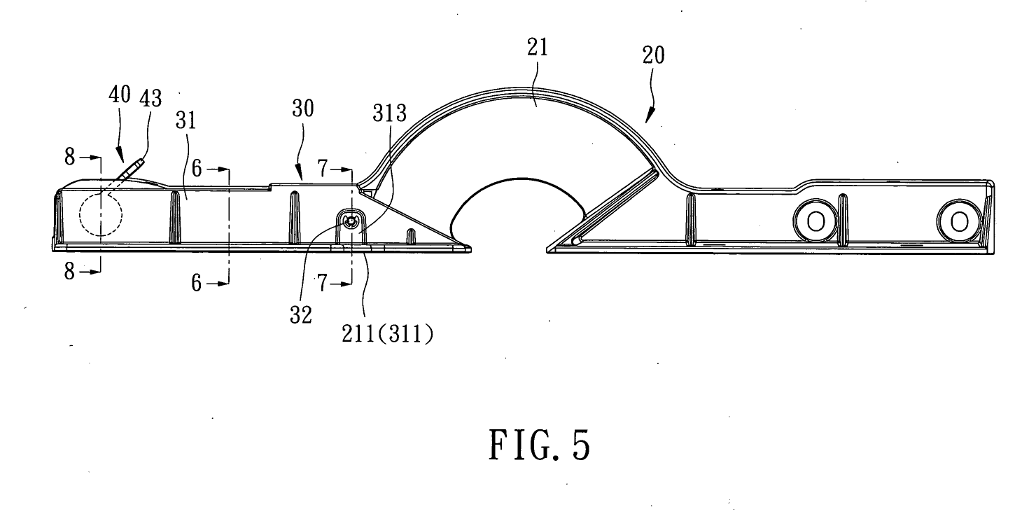

Referring to FIGS. 3, 4, and 5, the preferred embodiment of an abutment plate assembly according to this invention is adapted to be mounted on a cutting machine (not shown), and includes an abutment plate unit 20, an extension plate unit 30, and a locking unit 40 including a pressing member 41. When a cutting operation of the cutting machine is to be performed, a workpiece (not shown) can be moved to abut against the abutment plate assembly.

The abutment plate unit 20 includes a body 21 and a plurality of contact units 22. The body 21 includes an abutment surface 211 allowing the workpiece to abut thereagainst. The pressing member 41 is disposed on the body 21. An assembly of the pressing member 41 and the body 21 includes a horizontal sliding rail unit disposed at an upper portion thereof and having a generally T-shaped cross section, and a guide slot unit extending along a longitudinal direction of the sliding rail unit. The sliding rail unit includes a left rail segment 411 disposed on the pressing member 41, a right rail segment 212, and a middle rail segment 212′. The right and middle rail segments 212, 212′ are disposed on the body 21. The guide slot unit includes three slot portions 414, 213, 213′ formed respectively in the left, right, and middle rail segments 411, 212, 212′. The guide slot unit has two closed ends. The left end of the guide slot unit is formed in a top surface of the pressing member 41. The body 21 has an elongated top surface formed with an inclined guiding surface 214 at the left end thereof. The inclined guiding surface 214 is aligned with and adjacent to the left end of the guide slot unit for facilitating the assembly of the extension plate unit 30 to the abutment plate unit 20, which will be described hereinafter.

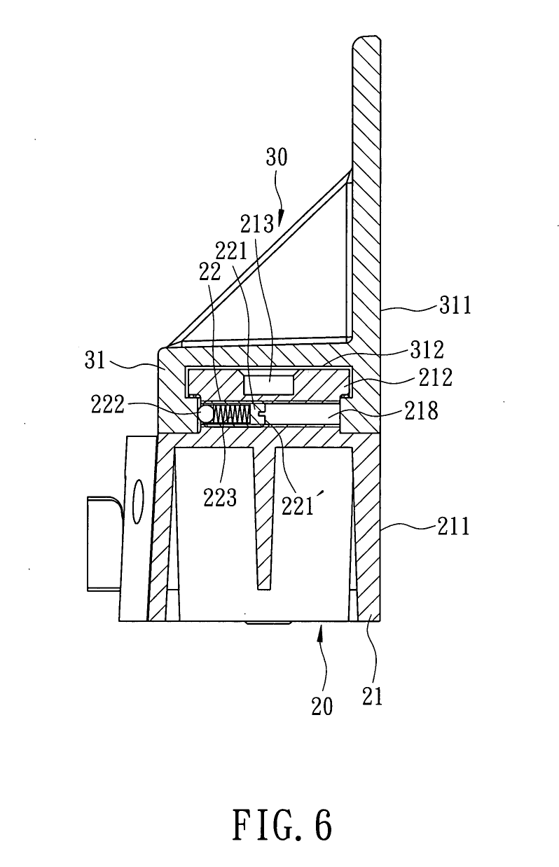

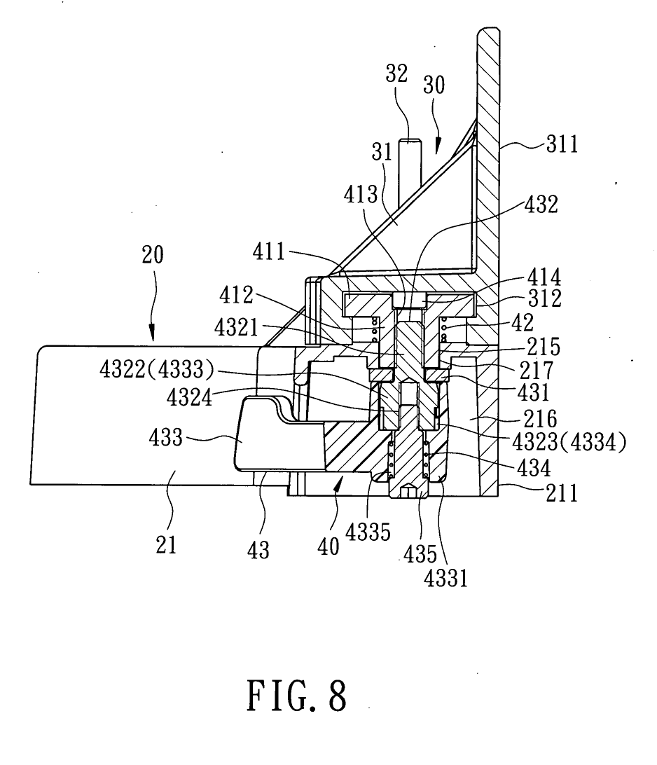

The top surface of the body 21 is further formed with a recess 215 disposed in proximity to the inclined guiding surface 214. The body 21 further has an accommodating space 216 (see FIG. 8) disposed under the recess 215, and a circular hole 217 in spatial communication with the recess 215 and the accommodating space 216. The sliding rail unit has a plurality of threaded holes 218 formed therethrough and aligned with each other along a horizontal direction for receiving the contact units 22, respectively. With further reference to FIG. 6, each of the contact units 22 includes an externally threaded hollow cylinder 221 engaging the corresponding threaded hole 218 in the sliding rail unit and having a front end wall 221′ and an open rear end, a contact member 222 configured as a ball and disposed movably within the hollow cylinder 221, and a spring 223 disposed within the hollow cylinder 221 between the contact member 222 and the front end wall 221′ for biasing the contact member 222 to project from the rear end of the hollow cylinder 221.

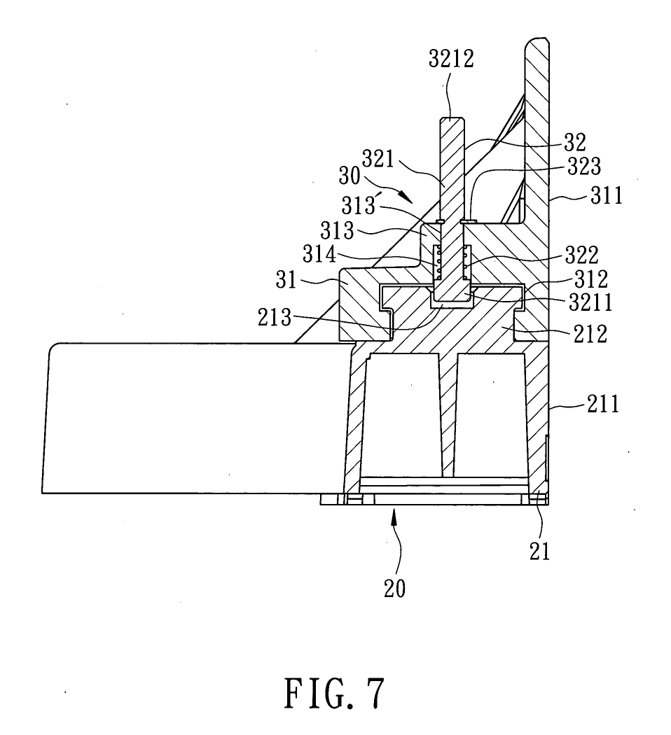

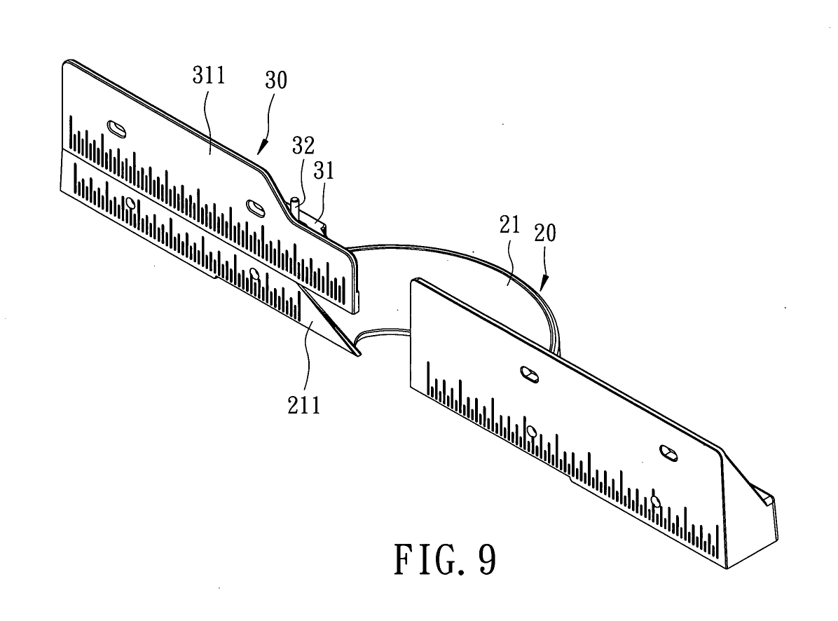

The extension plate unit 30 includes an extension plate 31 disposed movably on the body 21, and, with further reference to FIG. 7, a position-limiting unit 32. The position-limiting unit 32 has a lower end biased into the guide slot unit so as to prevent removal of the extension plate 31 from the body 21. The extension plate 31 has an abutment surface 311 aligned with the abutment surface 211 of the abutment plate unit 20, and a lower portion formed with a slide slot 312. The slide slot 312 has a generally T-shaped cross section, and engages the sliding rail unit of the abutment plate unit 20. The contact members 222 are biased to contact a wall of the extension plate 31 defining the slide slot 312 so as to maintain the alignment of the abutment surfaces 211, 311 of the body 21 and the extension plate 31. Hence, the abutment surfaces 211, 311 are coplanar, as shown in FIG. 9.

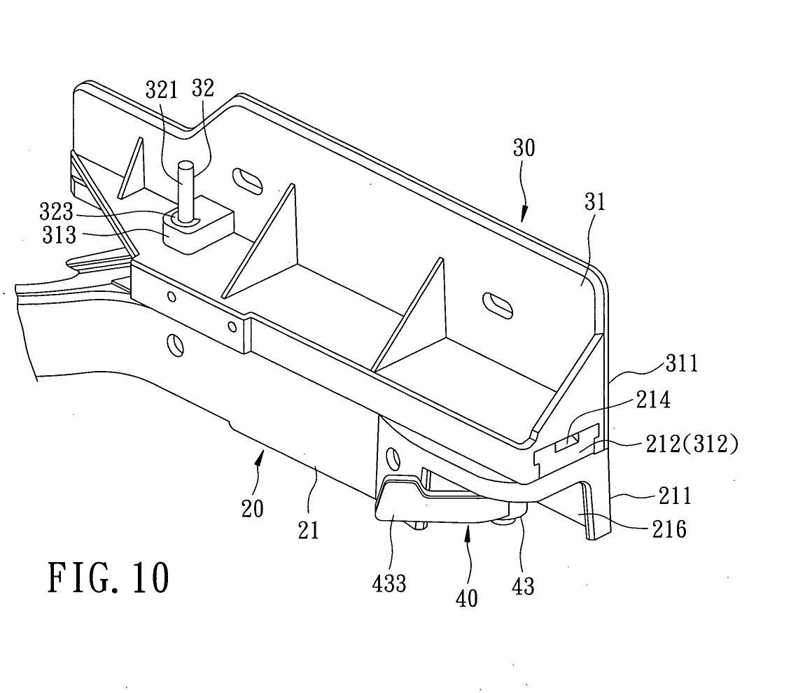

With particular reference to FIGS. 7 and 10, the extension plate 31 is formed with a hollow mounting projection 313 having a horizontal supporting wall 313′, and a counterbore 314 in spatial communication with the slide slot 312. The position-limiting unit 32 includes a vertical position-limiting rod 321, a biasing member 322, and a C-shaped retaining ring 323. The position-limiting rod 321 extends through and is movable vertically on the supporting wall 313′, and has an upper operation end 3212, and a lower end constituting the lower end of the position-limiting unit 32. In this embodiment, the lower end of the position-limiting rod 321 is formed with an outward flange 3211 extending radially and outwardly therefrom. The C-shaped retaining ring 323 is sleeved fixedly on the position-limiting rod 321, and abuts against a top surface of the supporting wall 313′. The biasing member 322 is disposed in the counterbore 314, and is configured as a coiled compression spring sleeved on the position-limiting rod 321 between the outward flange 3211 and the supporting wall 313′ so as to bias the outward flange 3211 to move downwardly away from the supporting wall 313′ into the guide slot unit in the abutment plate unit 20.

With further reference to FIGS. 3 and 8, the locking unit 40 further includes a resilient member 42, and a rotary lever unit 43. The pressing member 41 is movable vertically within the slide slot 312 in the extension plate unit 30. The rotary lever unit 43 is disposed in the accommodating space 216 in the body 21, and includes a driving member 432, and a rotary lever 433. The pressing member 41 further has a circular tubular portion 412 extending integrally from the left rail segment 411 into the circular hole 217 in the body 21 and formed with a first engagement portion 413 configured as a threaded hole. The resilient member 42 is sleeved on the circular tubular portion 412 of the pressing member 41 between the left rail segment 411 and the body 21 for biasing the pressing member 41 to move upwardly away from the body 21. The driving member 432 is configured as a bolt, and has a second engagement portion 4321 configured as an externally threaded rod and engaging the first engagement portion 413, and a head 4322 connected integrally to a lower end of the second engagement portion 4321. The head 4322 has an annular outer surface formed with a ratchet-toothed portion 4323, and a bottom surface formed with a threaded hole 4324. Since the guide slot unit has the closed ends and the outward flange 3211 of the position-limiting rod 321 is biased into the guide slot unit, undesirable removal of the extension plate unit 30 from the abutment plate unit 20 can be prevented. In an alternative embodiment, the left closed end of the guide slot unit may be disposed in the body 21.

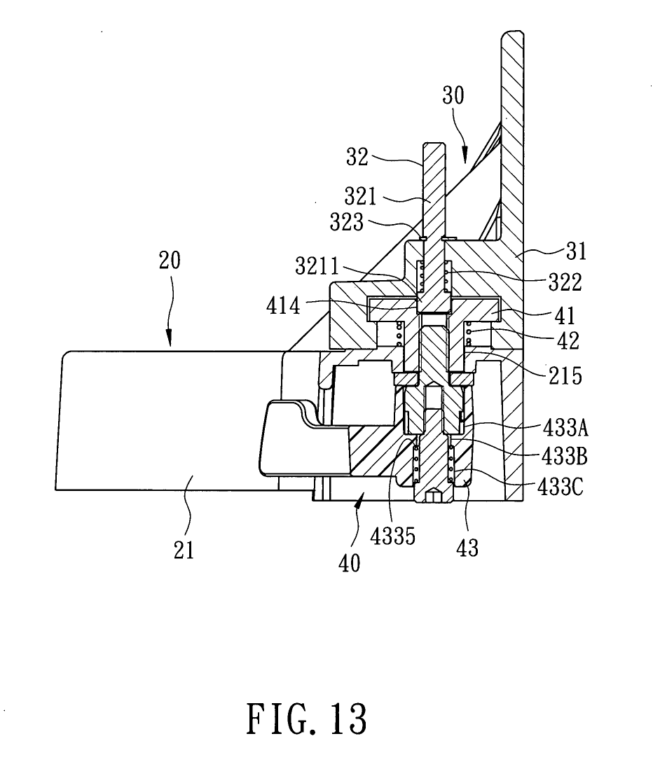

A washer 431 is sleeved on the threaded rod portion 4321 of the driving member 432, and abuts against the head 4322 of the driving member 432. As such, the washer 431 is biased by the resilient member 42 to contact a bottom surface of a wall of the body 21 defining the circular hole 217. Hence, when the driving member 432 is rotated, the pressing member 41 is moved vertically within the slide slot 312 in the extension plate 31. The rotary lever 433 is connected removably to the driving member 432 such that synchronous rotation of the rotary lever 433 and the driving member 432 is allowed. In this embodiment, the rotary lever 433 includes a sleeve member 4331 sleeved movably on the driving member 432, and a handle member 4332 extending integrally, radially, and outwardly from the sleeve member 4331. The sleeve member 4331 is formed with a stepped hole 4333 and an internally toothed annular surface portion 4334. As indicated in FIG. 13, the stepped hole 4333 has a large-diameter upper hole portion 433A, a small-diameter middle hole portion 433B, and a mediate-diameter lower hole portion 433C. The head 4332 of the driving member 432 is disposed in the large-diameter upper hole portion 433A. The rotary lever unit 43 further includes a spring-positioning bolt 435 engaging the threaded hole 4324 in the driving member 432 and having a head 4351 at a lower end thereof, and a spring member 434 configured as a coiled compression spring. The spring member 434 is sleeved on the spring-positioning bolt 435 between the head 4351 and a shoulder 4335 defined between the small-diameter middle hole portion 433B and the mediate-diameter lower hole portion 433C (see FIG. 13). As such, the internally toothed annular surface portion 4334 of the rotary lever 433 is biased by the spring member 434 to engage the ratchet-toothed portion 4323 of the driving member 432 so as to allow for rotation of the driving member 432 relative to the body 21 in only a predetermined direction. The rotary lever 433 is movable forcibly and downwardly relative to the body 21 against the biasing action of the spring member 434 so as to remove the internally toothed annular surface portion 4334 from the ratchet-toothed portion 4323, thereby allowing for rotation of the driving member 432 relative to the body 21 in two directions.

When it is desired to mount the extension plate unit 30 to the abutment plate unit 20, the position-limiting rod 321 is pulled upwardly relative to the extension plate 31 against the biasing action of the biasing member 322 so as to allow for both engagement of the left end of the sliding rail unit with the right end of the slide slot 312 and engagement of the outward flange 3211 of the position-limiting rod 321 with the inclined guiding surface 214. Next, the extension plate unit 30 is moved to the right on the abutment plate unit 20 until the outward flange 3211 of the position-limiting rod 321 is guided by the inclined guiding surface 214 to move into the guide slot unit in the abutment plate unit 20.

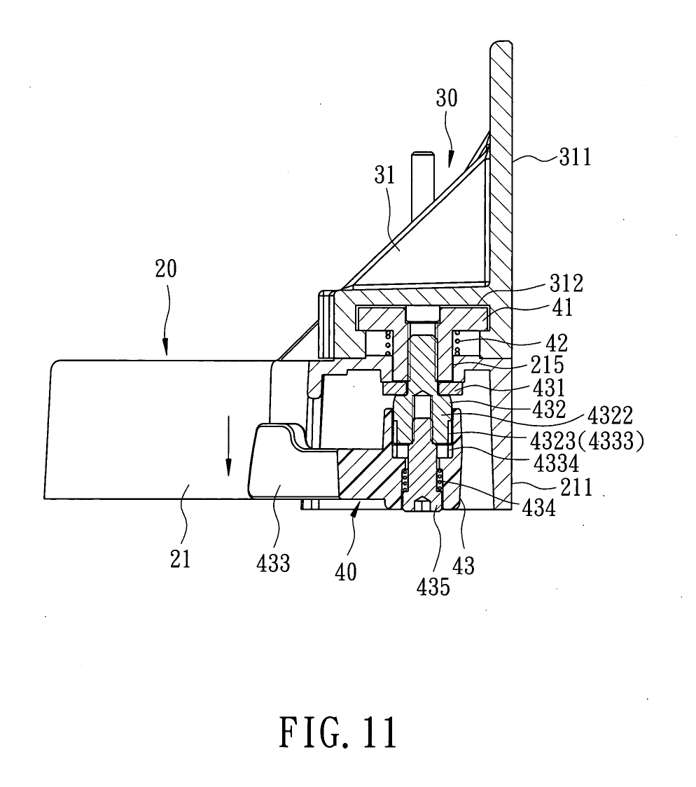

The rotary lever unit 43 is rotatable intermittently relative to the abutment plate unit 20 in the predetermined direction so as to move the pressing member 41 toward the abutment plate unit 20 until the pressing member 41 presses the extension plate unit 30 against the body 21 to thereby lock the extension plate unit 30 on the abutment plate unit 20. When the rotary lever unit 43 is rotated to a position whereat the handle member 4332 is impeded by the body 21 from further rotation in the predetermined direction, the rotary lever unit 43 is moved downwardly relative to the body 21 to remove the internally toothed annular surface portion 4334 from the ratchet-toothed portion 4323, as shown in FIG. 11, and the handle member 4332 is rotated in a direction opposite to the predetermined direction by an angle of about 180 degrees. Thereafter, the handle member 4332 is released to thereby allow the internally toothed annular surface portion 4334 to be biased by the spring member 434 to engage the ratchet-toothed portion 4323. Hence, the rotary lever unit 43 can be further rotated in the predetermined direction.

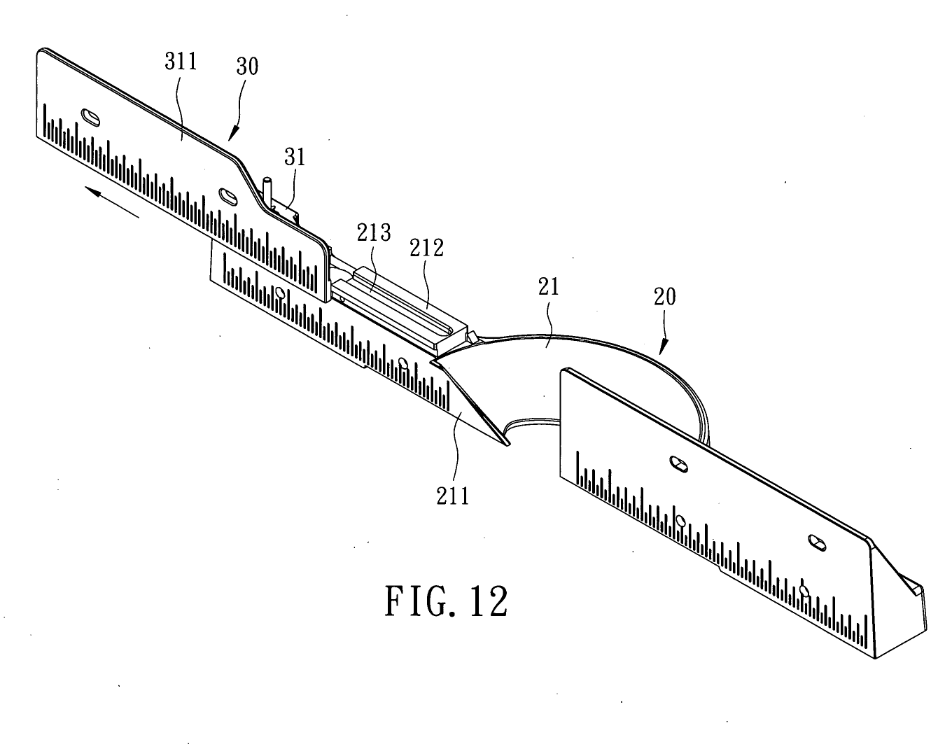

During movement of the extension plate unit 30 to the left on the abutment plate unit 20, when the outward flange 3211 of the position-limiting rod 321 is moved to the left end of the guide slot unit, as shown in FIGS. 12 and 13, since the outward flange 3211 is biased downwardly by the biasing member 322 into the guide slot unit, removal of the outward flange 3211 from the guide slot unit(S) can be prevented.

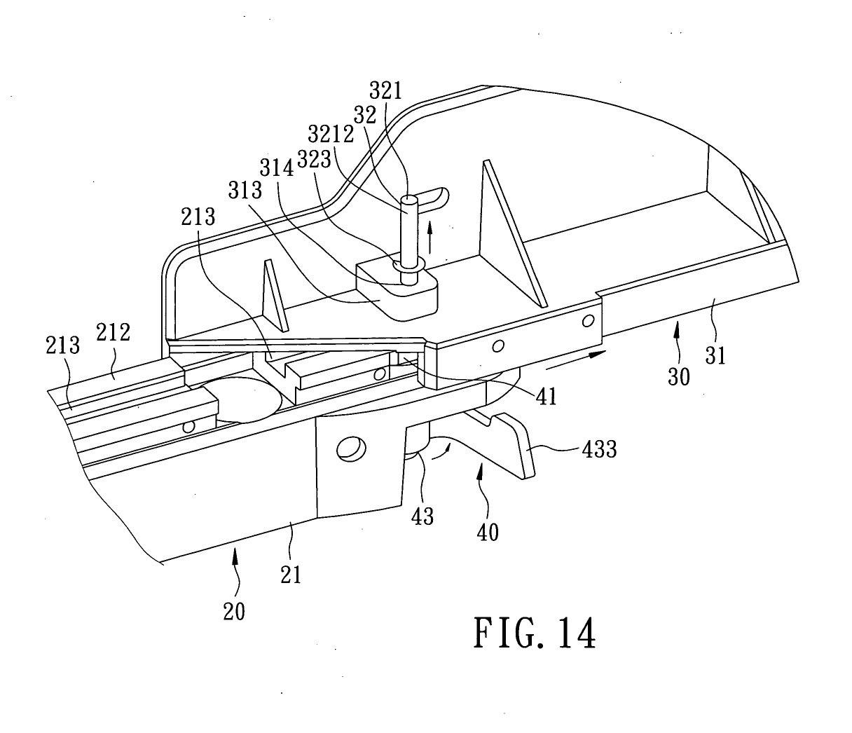

To remove the extension plate unit 30 from the abutment plate unit 20, the position-limiting rod 321 is pulled upwardly relative to the extension plate 31 to remove the outward flange 3211 from the guide slot unit, as shown in FIG. 14.

The abutment plate assembly of this invention has the following advantages:

(1) The sliding rail unit and the slide slot 312 are T-shaped in cross section, and thus serve as a dovetail tongue and groove assembly. Hence, the extension plate unit 30 can slide smoothly on the abutment plate unit 20.

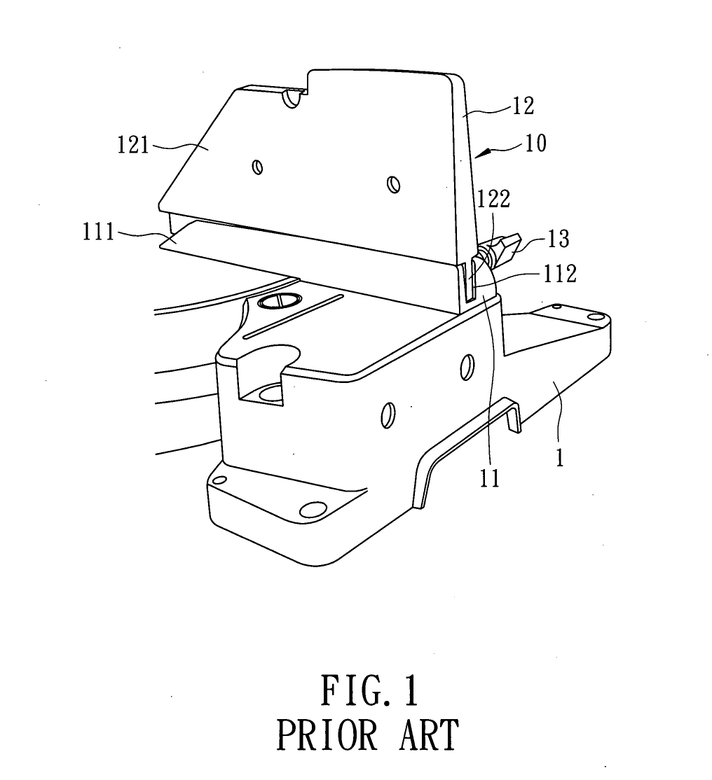

(2) The pressing member 41 is rectangular, and has two opposite sides movable downwardly to press against a wall of the extension plate 31 defining the slide slot 312. The contact area between the pressing member 41 and the extension plate 31 is greater than that between the lock bolt 13 (see FIG. 1) and the extension plate 12 (see FIG. 1) of the above-mentioned prior art. As a result, the extension plate unit 30 can be locked firmly on the abutment plate unit 20.

With this invention thus explained, it is apparent that numerous modifications and variations can be made without departing from the scope and spirit of this invention. It is therefore intended that this invention be limited only as indicated by the appended claims.

I claim:

1. An abutment plate assembly for a cutting machine, the cutting machine having a machine bed, said abutment plate assembly being adapted to allow a workpiece to abut thereagainst during a cutting operation of the cutting machine, said abutment plate assembly comprising:
an abutment plate unit including a body, said body including an abutment surface adapted to allow the workpiece to abut thereagainst, and a horizontal sliding rail unit disposed at an upper portion of said body and having a generally T-shaped cross section;
an extension plate unit including an extension plate disposed movably on said body of said abutment plate unit, said extension plate having an abutment surface aligned with said abutment surface of said body of said abutment plate unit, and a lower portion formed with a slide slot, said slide slot having a generally T-shaped cross section and engaging said sliding rail unit of said abutment plate unit; and
a locking unit including a pressing member movable vertically within said slide slot in said extension plate unit, a resilient member for biasing said pressing member to move away from said body of said abutment plate unit, and a rotary lever unit, said pressing member having a first engagement portion, said rotary lever unit having a second engagement portion that engages said first engagement portion, one of said first and second engagement portions being internally threaded and the other of said first and second engagement portions being externally threaded, said rotary lever unit being rotatable relative to said abutment plate unit so as to move said pressing member toward said abutment plate unit until said pressing member presses said extension plate of said extension plate unit against said body of said abutment plate unit to thereby lock said extension plate unit on said abutment plate unit.

2. The abutment plate assembly as claimed in claim 1, wherein said abutment plate unit further includes a plurality of spring-biased contact members aligned with each other and biased to contact a wall of said extension plate defining said slide slot so as to maintain alignment of said abutment surfaces of said body of said abutment plate unit and said extension plate of said extension plate unit.

3. The abutment plate assembly as claimed in claim 2, wherein said contact members are configured as balls.

4. The abutment plate assembly as claimed in claim 1, wherein
an assembly of said pressing member and said sliding rail unit of said abutment plate unit is formed with a guide slot unit extending along a longitudinal direction of said sliding rail unit; and
said extension plate unit further includes a position-limiting unit having a lower end biased into said guide slot unit so as to prevent removal of said extension plate of said extension plate unit from said body of said abutment plate unit.

5. The abutment plate assembly as claimed in claim 4, wherein said guide slot unit has two closed ends.

6. The abutment plate assembly as claimed in claim 5, wherein
said extension plate has a horizontal supporting wall; and
said position-limiting unit includes a vertical position-limiting rod extending through and movable vertically on said supporting wall of said extension plate, said position-limiting rod having a lower end constituting said lower end of said position-limiting unit,
a C-shaped retaining ring sleeved fixedly on said position-limiting rod and abutting against a top surface of said supporting wall, and
a biasing member for biasing said lower end of said position-limiting rod into said guide slot unit.

7. The abutment plate assembly as claimed in claim 6, wherein
said lower end of said position-limiting rod is formed with an outward flange extending radially and outwardly therefrom; and
said spring member is configured as a coiled compression spring sleeved on said position-limiting rod between said outward flange and said supporting wall so as to bias said outward flange to move downwardly away from said supporting wall.

8. The abutment plate assembly as claimed in claim 7, wherein said position-limiting rod is removable upwardly from said guide slot unit against biasing action of said biasing member so as to allow for disengagement of said sliding rail unit from said slide slot and, thus, separation of said extension plate unit from said abutment plate unit.

9. The abutment plate assembly as claimed in claim 8, wherein said body has an elongated top surface having an end formed with an inclined guiding surface, said inclined guiding surface being aligned with and adjacent to one of said closed ends of said guide slot unit for guiding said lower end of said position-limiting unit to move into said one of said closed ends of said guide slot unit when said extension plate unit is assembled to said abutment plate unit.

10. The abutment plate assembly as claimed in claim 4, wherein said pressing member is rectangular, and has two opposite sides movable downwardly to press against a wall of said extension plate defining said slide slot, said body of said abutment plate unit being elongated, and having a top surface formed with a recess, said pressing member being movable vertically within said recess, said one of said closed ends of said guide slot unit being formed in said top surface of said pressing member.

11. The abutment plate assembly as claimed in claim 1, wherein said rotary lever unit includes a driving member having said second engagement portion, and a rotary lever connected removably to said driving member such that synchronous rotation of said rotary lever and said driving member is allowed.

12. The abutment plate assembly as claimed in claim 11, wherein said first engagement portion of said pressing member is configured as a threaded hole, and said second engagement portion of said driving member is configured as an externally threaded rod.

13. The abutment plate assembly as claimed in claim 11, wherein said rotary lever includes a sleeve member sleeved movably on said driving member, and a handle member extending integrally, radially, and outwardly from said sleeve member, said sleeve member having an internally toothed annular surface portion, said driving member having an annular outer surface formed with a ratchet-toothed portion, said rotary lever unit further including a spring member for biasing said internally toothed annular surface portion of said rotary lever to engage said ratchet-toothed portion of said driving member so as to allow for rotation of said driving member relative to said body of said abutment plate unit in only a single direction, said rotary lever being movable forcibly relative to said body against biasing action of said spring member so as to remove said ratchet-toothed portion of said driving member from said ratchet toothed portion of said driving member, thereby allowing for rotation of said driving member relative to said body of said abutment plate unit in two directions.
